(19) United States
(12) Patent Application Publication
(10) Pub. No.: US 2025/0206345 A1
(43) Pub. Date: Jun. 26, 2025

(54) GENERATING VEHICLE TRAJECTORIES TO ACCOUNT FOR DEVIATIONS IN TRAINING TRAJECTORIES

(71) Applicant: Toyota Jidosha Kabushiki Kaisha, Toyota-Shi (JP)

(72) Inventors: YIMING ZHANG, San Mateo, CA (US); ZHAOYUAN HUO, Palo Alto, CA (US); AAYUSH AHUJA, Redwood City, CA (US); FLAVIO NARDI, Santa Clara, CA (US)

(21) Appl. No.: 18/392,639

(22) Filed: Dec. 21, 2023

(51) Int. Cl. B60W 60/00; B60W 30/095

(52) U.S. Cl. CPC B60W 60/0015; B60W 30/095

(57) ABSTRACT

Systems and methods are provided for training a machine learning model to generate a planned trajectory for an ego vehicle that accounts for deviations from expert trajectories used to train the machine learning model. Examples include obtaining a first trajectory for a machine learning model, the first trajectory comprises a sequence of a plurality of vehicle states, and perturbing at least one of the plurality of vehicle states. Examples also include generating a second trajectory based on the at least one perturbed vehicle state and smoothening the second trajectory to correspond to the first trajectory. Examples further include training the machine learning model using the smoothened second trajectory to produce a planned trajectory for controlling a vehicle.

### TECHNICAL FIELD

The present disclosure relates generally to machine learning, and in particular, some implementations relate to a machine learning system that perturbs training trajectories to train a machine learning model on deviations that occur in actual real-world trajectories.

### DESCRIPTION OF RELATED ART

Typically machine learning models are trained using data representative of ideal or expert trajectories. When deployed on a vehicle, the machine learning models aim to operate the vehicle to imitate the expert trajectories. However, when deployed, a vehicle may not be capable of perfectly imitating the expert trajectories and—even in a well-trained system—may be prone to small errors. The small errors may be compounded over time causing the vehicle to reach states that the machine learning model has never seen before in the expert trajectories, which can lead to system failures. Better machine learning models and/or methods are desired.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, a method is provided. The method comprises obtaining a first trajectory for a machine learning model, the first trajectory comprises a sequence of a plurality of vehicle states, and perturbing at least one of the plurality of vehicle states. The method also includes generating a second trajectory based on the at least one perturbed vehicle state and smoothening the second trajectory to correspond to the first trajectory. The method further includes training the machine learning model using the smoothened second trajectory to produce a planned trajectory for controlling a vehicle.

In another aspect, a system is provided that comprises a memory storing instructions and one or more processors communicably coupled to the memory. The one or more processors are configured to execute the instructions to obtain a training trajectory used to train a machine learning model, the training trajectory comprises a sequence of a plurality of vehicle states; perturb at least one of the plurality of vehicle states; and generate a modified training trajectory based on the at least one perturbed vehicle state and convergence to the training trajectory. The one or more processors are further configured to execute the instructions to training the machine learning model using the training trajectory to produce a planned trajectory.

In another aspect, a system is provided that comprises a memory storing instructions and one or more processors communicably coupled to the memory. The one or more processors are configured to execute the instructions to generate second trajectory data based on applying noise to first trajectory data; create create a collision loss function based on the second trajectory data; and train a machine learning model based on the second trajectory data and the collision loss function to generate planned trajectories for controlling a vehicle.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an illustrative representation of a computer system for implementing training on deviations from expert trajectories, in accordance with one or more embodiments of the disclosure.

FIG. 2 depicts an example expert trajectory and a modified trajectory, in accordance with one or more embodiments of the disclosure.

FIG. 3 depicts a schematic diagram of an example determination of a collision loss function, in accordance with one or more embodiments of the disclosure.

FIG. 4 is a schematic representation of an example hybrid vehicle with which embodiments of the systems and methods disclosed herein may be implemented.

FIG. 5 illustrates an example architecture for vehicular assisted behavior cloning in accordance with one embodiment of the systems and methods described herein.

FIG. 6 is a flow chart illustrating example operations for behavior cloning, in accordance with one or more embodiments of the disclosure.

FIG. 7 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technology provide for training a machine learning model to generate a planned trajectory for an ego vehicle that accounts for deviations from expert trajectories used to train the machine learning model. In various examples, a perturbation can be introduced at one or more states of an expert trajectory. For example, the perturbation may be introduced at an initial state. A modified expert trajectory can be produced by smoothing an effect of the perturbation on the expert trajectory. The modified expert trajectory, rather than the original expert trajectory, can be included in training data used to train the machine learning model. In some embodiments, a collision loss can be included in the machine learning model that such that an effect of possible collisions between the ego vehicle and road agents caused by the perturbations are introduced into the expert trajectory.

As alluded to above, when deployed on vehicles, machine learning models aim to operate the vehicles to imitate expert trajectories on which the machine learning model is trained. An example approach for building a data-driven planner for autonomous vehicles is through behavior cloning. In behavior cloning, training data can be collected from a subject while performing actions in the real-world. The collected data may be referred to herein as “expert data”. The expert data can be applied to a machine learning algorithm to generate a machine learning model that attempts to imitate the expert data by minimizing error terms between the expert data and states an autonomous or semi-autonomous device. In the context of autonomous vehicles, expert data may be collected from a vehicle operated in the real-world (e.g., by a human driver) and the machine learning model attempts to operate an autonomous or semi-autonomous vehicle to imitate the expert data.

However, when trained machine learning models are deployed, autonomous or semi-autonomous vehicles may not be able to perfectly imitate the expert data. The vehicles may be prone to small errors and may end up in states that have not been seen previously in the expert data. Moreover, this error may compound over time, which can lead to failures and unsafe conditions. This phenomenon is known as the covariate shift problem, where the issue is that autonomous or semi-autonomous vehicles perform poorly in states that the model was not trained on (e.g., unseen in the expert data).

Current machine learning models that produce planned trajectories for autonomous or semi-autonomous vehicles are trained from training datasets of expert trajectories. The expert trajectories represent a sequence of vehicle states that are derived from expert data. However, training on expert trajectories can cause problems when the autonomous or semi-autonomous vehicles experience deviations from the expert trajectories, which occur in actual real-world trajectories.

Such deviations can cause an autonomous or semi-autonomous vehicle to be in a state not anticipated by the machine learning model. For example, a vehicle that follows an expert trajectory may remain within an appropriate lane where a risk of collision is low. However, the vehicle may experience a deviation from the expert trajectory that causes the vehicle to be in a different lane. For example, the vehicle may detect a road agent that suddenly and unexpectedly enters a current, appropriate lane causing the vehicle to deviate into another lane. If this other lane is one in which oncoming traffic may be present, then this would be a state not anticipated by the machine learning model and would be associated with a higher risk of collision. As a result, the machine learning model may attempt to make abrupt corrections back to the expert trajectory, even if such a move would increase the risk of collision. This abrupt correction may be counter to a drivers input and may work against the drivers input. A another example, the machine learning model may fail, resulting in shutting down or making increasingly dangerous decisions that do not conform with any convention, expert or not.

Embodiments disclosed herein overcome the above technical shortcomings of prior behavior cloning approaches by providing machine learning models trained to take into account circumstances that may arise when an actual real-world trajectory deviates from an expert trajectory. For example, embodiments disclosed herein can obtain a first trajectory from a machine learning model. The first trajectory may be a training trajectory used to train the machine learning model, which can be an expert trajectory as discussed above. The first trajectory may comprise a sequence of vehicle states (sometimes referred to herein as training vehicle states). Each vehicle state comprises a vehicle position, a vehicle heading, and a vehicle speed based on sensor data collected while a vehicle executed the trajectory in the real-world world. One or more vehicle states of the first trajectory can be perturbed by applying noise to the one or more expert vehicle states. A second trajectory is generated based on the one or more perturbed vehicle states. In various examples, the one or more expert vehicle states are the initial vehicle state of the first trajectory (e.g., the foremost vehicle state in the sequence of expert vehicle states).

The second trajectory, which is based on the perturbations applied to the first trajectory, can be used to provide a more diverse set of training data, thus alleviating the covariate shift problem. However, random perturbations can lead to some issues when used to train a machine learning model. For example, the second trajectory may introduce physically infeasible trajectories and potentially unsafe vehicle states to the training data. If a machine learning model, trained on such physically infeasible trajectories and potentially unsafe vehicle states, is deployed on autonomous or semi-autonomous vehicles, these vehicles may attempt to imitate the infeasible trajectories and unsafe states. Accordingly, embodiments disclosed herein apply a smoothing to the second trajectory so to converge to the first trajectory subject to the one or more perturbed vehicle states. For example, the second trajectory includes an initial perturbed vehicle state and a sequence of vehicle states, from the perturbed vehicle state, are generated to ensure that the second trajectory converges to to the first trajectory, such that the two trajectories correspond to each other.

The resulting second trajectory, which represents a modified version of the first trajectory, is then added to training data and used to train or retrain the machine learning model. By including the second trajectory, the machine learning model can be trained to produce planned trajectories that account for deviations from an expert trajectory that may arise in actual real-world trajectories. As such, the second trajectory can be used to tackle the covariate shift problem, as well as ensuring planned trajectories are kinematically feasible and safe.

In some embodiments, a collision loss function can be introduced into the machine learning model to account for potentially unsafe scenarios that may arise when an actual trajectory deviates from an expert trajectory, such as collisions with other road agents (e.g. other vehicles, pedestrians, etc.). For example, the second trajectory generated above may introduce unsafe scenarios when attempting to match the first trajectory, such as when the second trajectory may intersect with a road agent. Using these unsafe scenarios to train the machine learning mode can lead to the autonomous or semi-autonomous vehicles attempting to imitate these potential unsafe scenarios. Thus, to ensure safety during deployment, the collision loss function is introduced to the machine learning model that penalizes collisions between the vehicle traveling along a planned trajectory and other road agents.

It should be noted that the terms “optimize,” “optimal”, “optimized” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

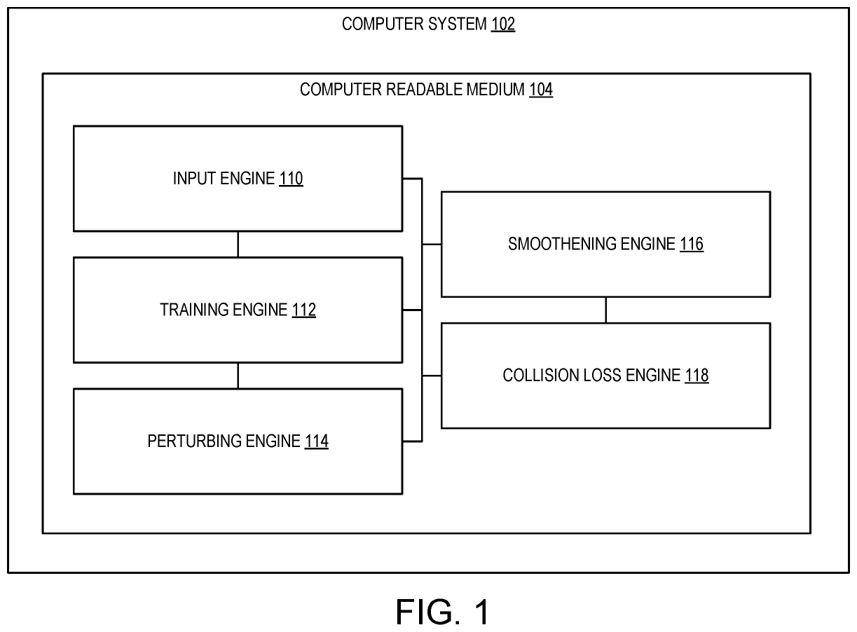

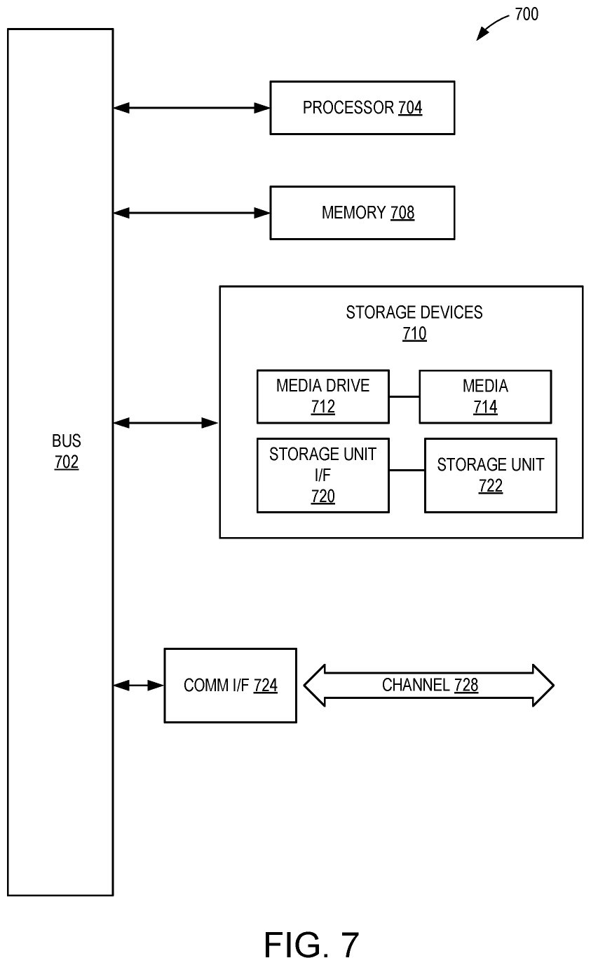

FIG. 1 is an illustrative representation of a computer system for implementing training on deviations from expert trajectories, in accordance with one or more embodiments of the disclosure. Computer system 102 may comprise computer readable medium 104, input engine 110, training engine 112, perturbing engine 114, smoothening engine 116, and collision loss engine 118. Other components and engines (e.g., processor, memory, etc.) have been removed from the illustration of computer system 102 in order to focus on these features. Additional features of computer system 102 are provided with FIG. 7.

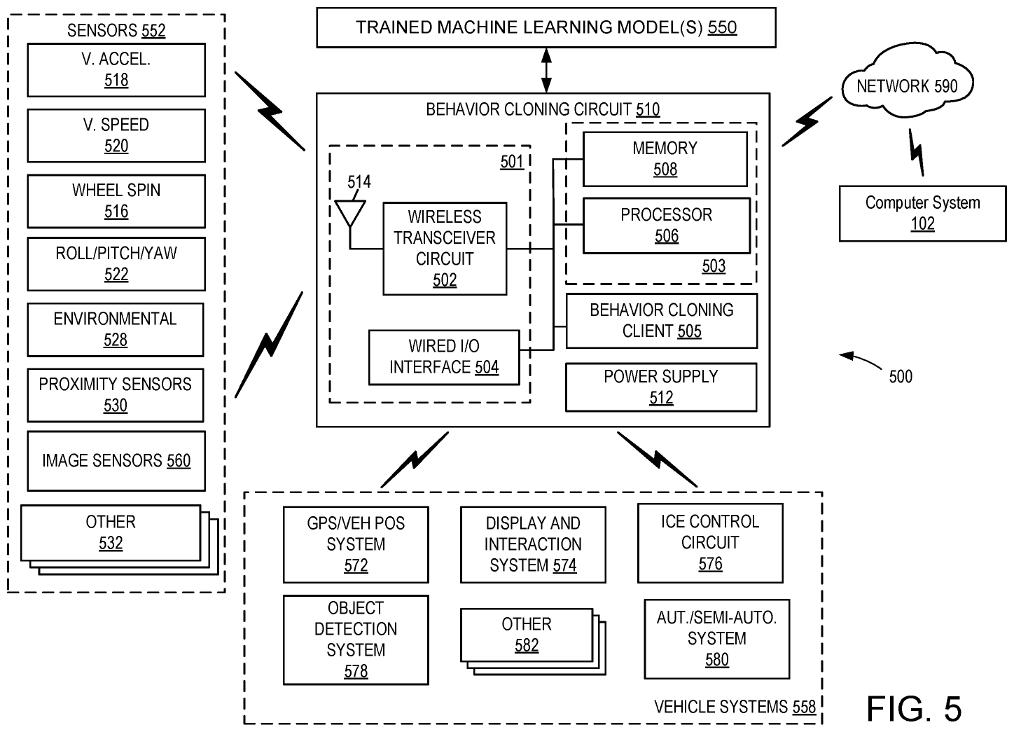

Input engine 110 is configured to receive and/or store input training data, such as training trajectories. Input engine 110 may be configured to store one or more training trajectories corresponding to expert trajectories. For example, input engine 110 may interact with a receiver configured to receive vehicle data from one or more sensors and/or subsystems of a vehicle (e.g., sensors 552 and/or vehicle systems 558 of FIG. 5). The vehicle data may be collected by the one or more sensors and/or subsystems while the vehicle is executing an expert trajectory in the real-world. The expert trajectories may be stored as training trajectories that can be used in training a machine learning model in a memory.

The training trajectories may comprise expert vehicle states of the one or more vehicles while the vehicles are executing expert trajectories in the real-world. Vehicle states can be determined from the collected vehicle data. For example, training trajectories may include a number N of trajectories (τ₀, τ₁, . . . , τ_{N}) based on vehicle data collected from one or more vehicles (sometimes referred to herein expert vehicle data). Each training trajectory may be composed of a sequence of vehicle states (s₀, s₁, . . . , s_{T}) over a period of time (T). The vehicle states may include vehicle position data, heading (ψ) data, and speed (ν) data, among other states. In some examples, the expert vehicle states may be received by input engine 110 from the one or more vehicles and used to construct the training trajectories. In another example, expert trajectories may be received from one or more vehicles and stored as training trajectories.

Training engine 112 is configured to train a machine learning model using training data. The training data may comprise the training trajectories collected by input engine 110, which are representative of expert trajectories. For example, the training data may comprise sequences of expert vehicle states. Thus, the training data may reflect expected movements or actions performed by the vehicle that the machine learning model will be trained to imitate

Training engine 112 may comprise a machine learning algorithm that is applied to the training trajectories to generate the machine learning model. When deployed, the machine learning model generates planned trajectories for operating autonomous or semi-autonomous vehicles. The planned trajectories attempt to imitate the training trajectories by minimizing error or loss terms between the training trajectories and actual real-world vehicle states of an autonomous or semi-autonomous vehicle while driving. For example, vehicle states may be input into a trained machine learning model, which outputs a planned trajectory for the autonomous or semi-autonomous vehicle. The planned trajectory can be used by autonomous or semi-autonomous driving systems to control the vehicle according to the planned trajectory.

However, as discussed above, when machine learning models are deployed, autonomous or semi-autonomous driving systems may not be able to perfectly imitate expert data. Thus, the vehicles may be prone to small errors and may end up in states not seen in expert data. These errors may compound over time, which can lead to failures in the system.

Accordingly, computer system 102 is configured to generate perturbed trajectories from the training trajectories. The perturbed trajectories can be included in training datasets and used to train the machine learning model to account for deviations from expert trajectories. To this end, perturbing engine 114 is configured to introduce a perturbation to one or more vehicle states of a training trajectory. The perturbation may be introduced as noise applied to components of the one or more vehicle states. To avoid physically impossible trajectories and potentially unsafe states to, smoothening engine 116 can be configured to produce a trajectory based on the training trajectory and the one or more perturbed vehicle states included as vehicles states of the training trajectory. In some examples, collision loss engine 118 can be configured to introduce collision loss into the machine learning model that penalizes unsafe scenarios (e.g., collisions with a road agent) that may arise along the resulting trajectory.

In an example, perturbing engine 114 may be configured to perturb an initial vehicle state of the training trajectory used to train the machine learning model. Perturbing engine 114 may be configured to apply a noise function to one or more components of the initial vehicle state. For example, as explained above, the training trajectory can comprise a sequence of vehicle states (s₀, s₁, . . . , s_{T}) and vehicle states may include vehicle position data, heading (ψ) data, and speed (ν) data, among other states as components. Perturbing engine 114 may be configured to apply a zero mean Gaussian noise to the position data and/or heading data components. For the speed data component, perturbing engine 114 may multiply a zero mean Gaussian noise with the speed data and add a bias term. The bias term can have a zero mean Gaussian distribution. Perturbing engine 114 may perturb the position data, heading (ψ) data, speed (ν) data, or any combination thereof to produce a perturbed vehicle state.

To prevent a trajectory, produced by the machine learning model based on the perturbed vehicle states, from causing vehicle to make abrupt changes in its movement that may be uncomfortable and/or unsafe, smoothening engine 116 may modify the training trajectory by using the perturbed initial state as an initial vehicle state and constraining the modified trajectory according to the training trajectory. In an example implementation, smoothening engine 116 may be implemented or otherwise comprise a controller (e.g., a proportional-integral-derivative (PID) controller) configured to modify the training trajectory with the perturbed initial state as an input (e.g., the desired setpoint of the PID controller) and a modified training trajectory as an output (e.g., the process variable). The controller may act to smooth the training trajectory with the perturbed initial state to produce a modified trajectory.

The modified trajectory generated by smoothening engine 116 can be included in datasets used by training engine 112 to train the machine learning model for behavior cloning. The modified trajectory may be included as a new training trajectory. In some examples, the training data may be updated by replacing the original training trajectory with the new training trajectory generated by smoothening engine 116. In another example, both the original and new training trajectories may be included in training data.

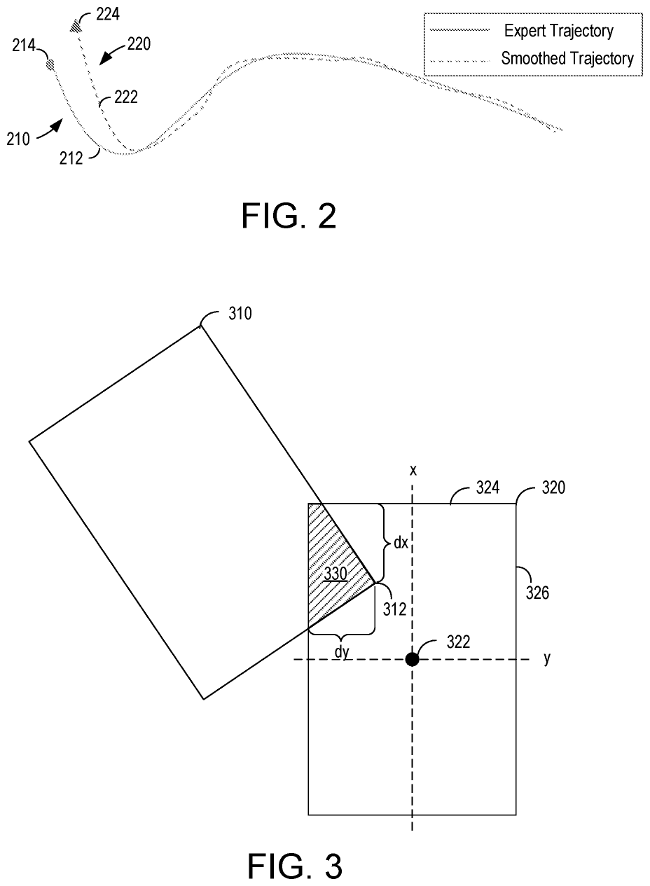

FIG. 2 depicts an example expert trajectory 210 and a modified trajectory 220, in accordance with one or more embodiments of the disclosure. The expert trajectory 210 comprises a sequence of vehicle states that collectively form path 212, as explained above, with an initial vehicle state 214 shown in FIG. 2. The expert trajectory 210 may be an example of a training trajectory used to train a machine learning model.

The modified trajectory 220 also comprises a sequence of vehicle states that collectively form a modified path 222. Modified trajectory 220 includes a perturbed initial vehicle state 224. For example, perturbing engine 114 may have been executed to perturbed one or more components of the initial vehicle state 214 to generate perturbed vehicle state 224.

From the perturbed vehicle state 224, smoothening engine 116 generate a modified path 222 that matches or corresponds to (e.g., aligns with) the expert trajectory 210. To achieve this, smoothening engine 116 can execute a controller with the perturbed vehicle state 224 as the initial state of the controller and the expert trajectory as the controller's target. The controller then executes a control loop with feedback to output the modified trajectory 220 as a measured process variable. For example, the controller may calculate a difference between a set point (e.g., the expert trajectory) and an input (e.g., the perturbed vehicle state 224) and determine vehicle states of the modified trajectory 220. Through this process, the modified trajectory is constrained to correspond to or otherwise converge to the expert trajectory, but for the perturbed vehicle state 224 as shown in FIG. 2.

Returning back to FIG. 1, since the modified trajectory generated by smoothening engine 116 is not from expert data, the modified trajectory may contain potentially unsafe scenarios, such as collisions with other road agents (e.g. other vehicles, pedestrians, etc.). Using these unsafe scenarios as part of the expert data, which the machine learning models imitates, can lead to a planned trajectory imitating the modified trajectory that includes potential unsafe behaviors. To ensure safety during the deployment phase of the self-driving vehicle, collision loss engine 118 is configured to introduce a collision loss term to the machine learning algorithm, such perturbing engine 114 generates a machine model that penalizes collisions between modified trajectory and other road agents.

For example, the expert data collected by input engine 110 may include extrinsic states that represent environmental conditions surrounding the vehicles while collecting the expert vehicle states. These environmental conditions may include road agents detected in the surroundings, such as other vehicles, pedestrians, road side structures, etc. The road agents may be detected by sensors or subsystems of the vehicle and may be represented as a bounding box that creates a collision box for the road agent. Bounding boxes of detected road agents may be provided as part of the expert data collected by the vehicle, along with position data, heading data, and speed data for each road agent. Conventionally, the extrinsic states may be provided to training engine 112, along with the training trajectories based on expert data, and used to train the machine learning model to generate planned trajectories that imitate the expert trajectory and avoid the road agents.

However, as noted above, embodiments herein generate new training trajectories by perturbing one or more expert vehicle states, which can result in a trajectory that intersects with bounding boxes of road agents in the extrinsic states. To avoid such collisions, collision loss engine 118 introduces a collision loss function that penalizes planned trajectories generated by a trained machine learning model based on an amount of overlap between a road agent and an ego vehicle.

For example, collision loss engine 118 may determine the collision loss function from a relationship between a bounding box for the ego vehicle and a bounding box of a road agent. The bounding boxes of the road agent and ego vehicle may be obtained from the vehicle data. A collision can be represented by an overlap of the bounding boxes. The collision loss function can be based on an observation that when a collision occurs, a rate of change of a longitudinal position of the ego vehicle (e.g., dx) and/or a rate of change of a lateral position of the ego vehicle (e.g., dy) may be negative. The magnitudes of the rates of change may be proportional to a degree of overlap of the bounding boxes and the collision loss function can be proportional to these rates of change. Thus, the collision loss function can be differentiable and can be used in conjunction with the standard behavior cloning loss and optimized via backpropagation.

FIG. 3 depicts a schematic diagram of an example determination of a collision loss function, in accordance with one or more embodiments of the disclosure. FIG. 3 illustrates a road agent bounding box 310 and an ego vehicle bounding box 320. A Cartesian coordinate system can be defined having an origin at a center 322 of bounding box 320. An overlap region 330 may represent a collision that may occur between the ego vehicle and the road agent, for example, due to a modified trajectory generated by smoothening engine 116.

The collision loss can be determined based on the geometry of the bounding boxes 320 and 310. A collision can be recorded if any one of the corners of the bounding box 310 is inside bounding box 320. For example, for each corner of the bounding box 310, a determination is made as to whether or not the corner is inside or outside of the bounding box 320 based on the coordinate system. This determination is made by computing a difference between an edge of the bounding box 320 and a position of each corner of bounding box 310 along both the x-and y-axis. When the differences are negative for a given corner, the corner can be considered to lie within the bounding box 320, otherwise the corner is outside of the bounding box 320. The process can be performed for each corner, and, if any one is within the bounding box, a collision can be recorded.

As an illustrative example, consider corner 312 of bounding box 310. To determine if corner 312 is inside the bounding box 320, a first difference (dx) can be computed as the difference between a position of corner 312 along the x-and the position of edge 324 on the x-axis. A second difference (dy) can be computed as the difference between the position of corner 312 along the y-axis and the position of edge 326 on the y-axis. If both the first and second differences (dx and dy) are negative (e.g., max(dx,dy)<0), otherwise the corner can be considered outside of the bounding box 320. As shown in FIG. 3, corner 312 is within the bounding box 320 and both the first difference and second difference are negative.

Once a collision is recorded, the collision loss can be computed as proportional to a magnitude of the overlap of the bounding box 310 with bounding box 320. For example, the magnitude of the overlap can be computed as the maximum of the absolute value of the first and second differences (e.g., max(dx, dy)) of each corner of bounding box 310 determined to be within the bounding box 320. That is, for example, each corner determined to be within bounding box 310 is associated with a respective dx, dy value. The maximum absolute value of all the respective dx, dy values represents the corner that overlaps the deepest into the bounding box 320, and thus the magnitude of the overlap. IN the example of FIG. 3, only corner 312 is within bounding box 320 and thus the maximum of the absolute values of dx and dy shown in FIG. 3 represents the magnitude of the overlap.

Referring back to FIG. 1, once collision loss engine 118 can be configured to provide a collision loss function based on the magnitude of the overlap of the collision. Collision loss engine 118 can be configured to add the collision loss function to the machine learning model via training engine 112. Training engine 112 can then train the model on penalizing modified trajectories from smoothening engine 116 using the collision loss function. The penalties applied may be proportional to magnitude of the overlap between bounding boxes of a road agent with a bounding box of the ego vehicle. For example, given a known bounding box of an ego vehicle and a bounding box of a road agent (e.g., obtained from vehicle data) and a modified trajectory from smoothening engine 116, the collision loss function can compute collision loss terms to be minimized by the machine learning model when generating planned trajectories.

Training engine 112 is configured to apply the modified trajectory as a new training trajectory to retrain the machine learning model subject to the collision loss term. Once trained, the machine learning model can be deployed onto vehicles for generating planned trajectories that can account for deviations in actual trajectories relative to training trajectories, as well as being kinematically feasible and safe.

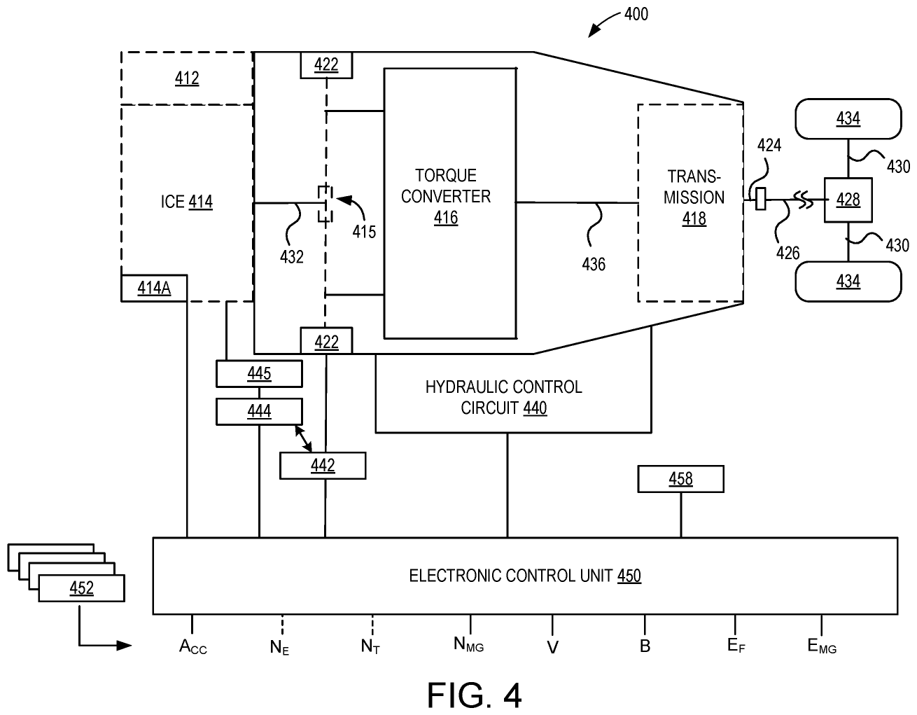

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 4. Although the example described with reference to FIG. 4 is a hybrid type of vehicle, the systems and methods for behavior cloning can be implemented in other types of vehicle including gasoline-or diesel-powered vehicles, fuel-cell vehicles, electric vehicles, or other vehicles.

FIG. 4 illustrates a drive system of an example vehicle 400 that may include an internal combustion engine 414 and one or more electric motors 422 (which may also serve as generators) as sources of motive power. Driving force generated by the internal combustion engine 414 and motors 422 can be transmitted to one or more wheels 434 via a torque converter 416, a transmission 418, a differential gear device 428, and a pair of axles 430.

As an HEV, vehicle 400 may be driven/powered with either or both of engine 414 and the motor(s) 422 as the drive source for travel. For example, a first travel mode may be an engine-only travel mode that only uses internal combustion engine 414 as the source of motive power. A second travel mode may be an EV travel mode that only uses the motor(s) 422 as the source of motive power. A third travel mode may be an HEV travel mode that uses engine 414 and the motor(s) 422 as the sources of motive power. In the engine-only and HEV travel modes, vehicle 400 relies on the motive force generated at least by internal combustion engine 414, and a clutch 415 may be included to engage engine 414. In the EV travel mode, vehicle 400 is powered by the motive force generated by motor 422 while engine 414 may be stopped and clutch 415 disengaged.

Engine 414 can be an internal combustion engine such as a gasoline, diesel or similarly powered engine in which fuel is injected into and combusted in a combustion chamber. A cooling system 412 can be provided to cool the engine 414 such as, for example, by removing excess heat from engine 414. For example, cooling system 412 can be implemented to include a radiator, a water pump and a series of cooling channels. In operation, the water pump circulates coolant through the engine 414 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 414. In other applications, either or both the water pump and the fan may be operated by electric current such as from battery 444.

An output control circuit 414A may be provided to control drive (output torque) of engine 414. Output control circuit 414A may include a throttle actuator to control an electronic throttle valve that controls fuel injection, an ignition device that controls ignition timing, and the like. Output control circuit 414A may execute output control of engine 414 according to a command control signal(s) supplied from an electronic control unit 450, described below. Such output control can include, for example, throttle control, fuel injection control, and ignition timing control.

Motor 422 can also be used to provide motive power in vehicle 400 and is powered electrically via a battery 444. Battery 444 may be implemented as one or more batteries or other power storage devices including, for example, lead-acid batteries, nickel-metal hydride batteries, lithium ion batteries, capacitive storage devices, and so on. Battery 444 may be charged by a battery charger 445 that receives energy from internal combustion engine 414. For example, an alternator or generator may be coupled directly or indirectly to a drive shaft of internal combustion engine 414 to generate an electrical current as a result of the operation of internal combustion engine 414. A clutch can be included to engage/disengage the battery charger 445. Battery 444 may also be charged by motor 422 such as, for example, by regenerative braking or by coasting during which time motor 422 operates as generator.

Motor 422 can be powered by battery 444 to generate a motive force to move the vehicle and adjust vehicle speed. Motor 422 can also function as a generator to generate electrical power such as, for example, when coasting or braking. Battery 444 may also be used to power other electrical or electronic systems in the vehicle. Motor 422 may be connected to battery 444 via an inverter 442. Battery 444 can include, for example, one or more batteries, capacitive storage units, or other storage reservoirs suitable for storing electrical energy that can be used to power motor 422. When battery 444 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 450 (described below) may be included and may control the electric drive components of the vehicle as well as other vehicle components. For example, electronic control unit 450 may control inverter 442, adjust driving current supplied to motor 422, and adjust the current received from motor 422 during regenerative coasting and breaking. As a more particular example, output torque of the motor 422 can be increased or decreased by electronic control unit 450 through the inverter 442.

A torque converter 416 can be included to control the application of power from engine 414 and motor 422 to transmission 418. Torque converter 416 can include a viscous fluid coupling that transfers rotational power from the motive power source to the driveshaft via the transmission. Torque converter 416 can include a conventional torque converter or a lockup torque converter. In other embodiments, a mechanical clutch can be used in place of torque converter 416.

Clutch 415 can be included to engage and disengage engine 414 from the drivetrain of the vehicle. In the illustrated example, a crankshaft 432, which is an output member of engine 414, may be selectively coupled to the motor 422 and torque converter 416 via clutch 415. Clutch 415 can be implemented as, for example, a multiple disc type hydraulic frictional engagement device whose engagement is controlled by an actuator such as a hydraulic actuator. Clutch 415 may be controlled such that its engagement state is complete engagement, slip engagement, and complete disengagement complete disengagement, depending on the pressure applied to the clutch. For example, a torque capacity of clutch 415 may be controlled according to the hydraulic pressure supplied from a hydraulic control circuit 440. When clutch 415 is engaged, power transmission is provided in the power transmission path between the crankshaft 432 and torque converter 416. On the other hand, when clutch 415 is disengaged, motive power from engine 414 is not delivered to the torque converter 416. In a slip engagement state, clutch 415 is engaged, and motive power is provided to torque converter 416 according to a torque capacity (transmission torque) of the clutch 415.

As alluded to above, vehicle 400 may include an electronic control unit 450. Electronic control unit 450 may include circuitry to control various aspects of the vehicle operation. Electronic control unit 450 may include, for example, a microcomputer that includes one or more processing units (e.g., microprocessors), memory storage (e.g., RAM, ROM, etc.), and I/O devices. The processing units of electronic control unit 450, execute instructions stored in memory to control one or more electrical systems or subsystems 458 in the vehicle. Electronic control unit 450 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 4, electronic control unit 450 receives information from a plurality of sensors included in vehicle 400. For example, electronic control unit 450 may receive signals that indicate vehicle operating conditions or characteristics, or signals that can be used to derive vehicle operating conditions or characteristics. These may include, but are not limited to accelerator operation amount (A_{CC}), a revolution speed (N_{E}) of internal combustion engine 414 (engine RPM), a rotational speed (N_{MG}) of the motor 422 (motor rotational speed), and vehicle speed (N_{V}). These may also include torque converter 416 output (N_{T}) (e.g., output amps indicative of motor output), brake operation amount/pressure (B), and battery SOC (i.e., the charged amount for battery 444 detected by an SOC sensor). Accordingly, vehicle 400 can include a plurality of sensors 452 that can be used to detect various conditions internal or external to the vehicle, and provide sensed conditions to electronic control unit 450 (which, again, may be implemented as one or a plurality of individual control circuits). In one embodiment, sensors 452 may be included to detect one or more conditions directly or indirectly such as, for example, fuel efficiency (E_{F}), motor efficiency (E_{MG}), hybrid (internal combustion engine 414+MG 422) efficiency, acceleration (A_{CC}), etc.

In some embodiments, one or more of the sensors 452 may include their own processing capability to compute the results for additional information that can be provided to electronic control unit 450. In other embodiments, one or more sensors may be data-gathering-only sensors that provide only raw data to electronic control unit 450. In further embodiments, hybrid sensors may be included that provide a combination of raw data and processed data to electronic control unit 450. Sensors 452 may provide an analog output or a digital output.

Sensors 452 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 400, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 4 is provided for illustration purposes only as one example of vehicle systems with which embodiments of the disclosed technology may be implemented. One of ordinary skill in the art reading this description will understand how the disclosed embodiments can be implemented with this and other vehicle platforms.

FIG. 5 illustrates an example architecture for behavior cloning in accordance with one embodiment of the systems and methods described herein. Referring now to FIG. 5, in this example, behavior cloning system 500 includes a behavior cloning circuit 510, a plurality of sensors 552 and a plurality of vehicle systems 558. Sensors 552 (such as sensors 452 described in connection with FIG. 4) and vehicle systems 558 (such as subsystems 458 described in connection with FIG. 4) can communicate with behavior cloning circuit 510 via a wired or wireless communication interface. Although sensors 552 and vehicle systems 558 are depicted as communicating with behavior cloning circuit 510, they can also communicate with each other as well as with other vehicle systems. behavior cloning circuit 510 can be implemented as an ECU or as part of an ECU such as, for example electronic control unit 450. In other embodiments, behavior cloning circuit 510 can be implemented independently of the ECU.

As shown in FIG. 5 and described herein, behavior cloning circuit 510 may be communicatively coupled to computer system 102 via network 590. As described in connection with FIG. 1, computer system 102 may comprise one or more engines, including input engine 110, training engine 112, perturbing engine 114, smoothening engine 116, and collision loss engine 118. These engines may be configured to perturb one or more vehicle states of training trajectories used to train a machine learning model; based on the perturbed vehicle states, generate a modified trajectory that converges with the training trajectory; and train the machine learning model using the modified trajectory. In some examples, the engines may be configured to introduce a collision loss function to the training.

The information output by computer system 102 may be conveyed to behavior cloning circuit 510 which may be on board a vehicle, such as vehicle 400. For example, the information may be uploaded as an executable file to the vehicle as one or more trained machine learning models 550. Behavior cloning circuit 510 may obtain information from sensors 552 and/or vehicle systems 558, such as vehicle data, and process the information through the trained machine learning model 550 to assist in the vehicle, such as through autonomous or semi-autonomous driving systems 580, as described below. For example, one or more trained machine learning models 550 may use the vehicle data to generate a planned trajectory that the autonomous or semi-autonomous driving systems 580 can leverage of operating the vehicle through behavior cloning. Autonomous or semi-autonomous driving systems 580 may attempt to imitate the planned trajectory.

As another example, information may be conveyed from behavior cloning circuit 510 to computer system 102, such as vehicle data, for use in training a machine learning model. In this case, behavior cloning circuit 510 may obtain vehicle data while the vehicle is executing maneuvers in the real-world, and upload this information to computer system 102. Computer system 102 may collect the information as training trajectories for generating one or more trained machine learning models 550.

Behavior cloning circuit 510 in this example includes a communication circuit 501, a decision circuit 503 (including a processor 506 and memory 508 in this example) and a power supply 512. Components of behavior cloning circuit 510 are illustrated as communicating with each other via a data bus, although other communication in interfaces can be included. Behavior cloning circuit 510 in this example also includes behavior cloning client 505 that can be operated to connect to an edge server of a network 590 to contribute vehicle data (e.g., sensor data) to computer system 102, for example, for training of machine learning models and/or to one or more trained machine learning models 550 for use by vehicle systems 558.

Processor 506 can include one or more GPUs, CPUs, microprocessors, or any other suitable processing system. Processor 506 may include a single core or multicore processors. The memory 508 may include one or more various forms of memory or data storage (e.g., flash, RAM, etc.) that may be used to store instructions and variables for processor 506 as well as any other suitable information, such as, one or more of the following elements: position data; vehicle speed data; heading direction data, trajectory data, along with other data as needed. Memory 508 can be made up of one or more modules of one or more different types of memory, and may be configured to store data and other information as well as operational instructions that may be used by the processor 506 to behavior cloning circuit 510.

Although the example of FIG. 5 is illustrated using processor and memory circuitry, as described below with reference to circuits disclosed herein, decision circuit 503 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a behavior cloning circuit 510.

Communication circuit 501 includes either or both a wireless transceiver circuit 502 with an associated antenna 514 and a wired I/O interface 504 with an associated hardwired data port (not illustrated). Communication circuit 501 can provide for vehicle-to-everything (V2X) and/or vehicle-to-vehicle (V2V) communications capabilities, allowing behavior cloning circuit 510 to communicate with edge devices, such as roadside unit/equipment (RSU/RSE), network cloud servers and cloud-based databases, and/or other vehicles via network 590. For example, V2X communication capabilities allows behavior cloning circuit 510 to communicate with edge/cloud servers, roadside infrastructure (e.g., such as roadside equipment/roadside unit, which may be a vehicle-to-infrastructure (V2I)-enabled street light or cameras, for example), etc. behavior cloning circuit 510 may also communicate with other connected vehicles over vehicle-to-vehicle (V2V) communications.

As this example illustrates, communications with behavior cloning circuit 510 can include either or both wired and wireless communications circuits 501. Wireless transceiver circuit 502 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 514 is coupled to wireless transceiver circuit 502 and is used by wireless transceiver circuit 502 to transmit radio signals wirelessly to wireless equipment with which it is connected and to receive radio signals as well. These RF signals can include information of almost any sort that is sent or received by behavior cloning circuit 510 to/from other entities such as sensors 552 and vehicle systems 558.

Wired I/O interface 504 can include a transmitter and a receiver (not shown) for hardwired communications with other devices. For example, wired I/O interface 504 can provide a hardwired interface to other components, including sensors 552 and vehicle systems 558. Wired I/O interface 504 can communicate with other devices using Ethernet or any of a number of other wired communication protocols whether standardized, proprietary, open, point-to-point, networked or otherwise.

Power supply 512 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 552 can include, for example, sensors 452 such as those described above with reference to the example of FIG. 4. Sensors 552 can include additional sensors that may or may not otherwise be included on a standard vehicle with which the behavior cloning system 500 is implemented. In the illustrated example, sensors 552 include vehicle acceleration sensors 518, vehicle speed sensors 520, wheelspin sensors 516 (e.g., one for each wheel), accelerometers such as a 4-axis accelerometer 522 to detect roll, pitch and yaw of the vehicle, environmental sensors 528 (e.g., to detect salinity or other environmental conditions), and proximity sensor 530 (e.g., sonar, radar, lidar or other vehicle proximity sensors). Additional sensors 532 can also be included as may be appropriate for a given implementation of behavior cloning system 500.

System 500 may be equipped with one or more image sensors 560. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 560 can be used to, for example, to detect objects in an environment surrounding a vehicle comprising behavior cloning system 500, for example, surrounding vehicles, roadway environment, road lanes, road curvature, obstacles, and so on. For example, a one or more image sensors 560 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 560 may include cameras that may be used with and/or integrated with other proximity sensors 530 such as LIDAR sensors or any other sensors capable of capturing a distance. As used herein, a sensor set of a vehicle may refer to sensors 552.

Vehicle systems 558, for example, systems and subsystems 458 described above with reference to the example of FIG. 4, can include any of a number of different vehicle components or subsystems used to control or monitor various aspects of the vehicle and its performance. In this example, the vehicle systems 558 includes a vehicle positioning system 572; engine control circuits 576 to control the operation of engine (e.g. internal combustion engine 414 and/or motors 422); object detection system 578 to perform image processing such as object recognition and detection on images from image sensors 560, proximity estimation, for example, from image sensors 560 and/or proximity sensors, etc. for use in other vehicle systems; vehicle display and interaction system 574 (e.g., vehicle audio system for broadcasting notifications over one or more vehicle speakers), vehicle display system and/or the vehicle dashboard system), and other vehicle systems 582 (e.g., Advanced Driver-Assistance Systems (ADAS), autonomous or semi-autonomous driving systems 580, such as forward/rear collision detection and warning systems, pedestrian detection systems, autonomous or semi-autonomous driving systems, and the like).

Autonomous or semi-autonomous driving systems 580 can be operatively connected to the various vehicle systems 558 and/or individual components thereof. For example, autonomous or semi-autonomous driving systems 580 can send and/or receive information from the various vehicle systems 558 to control the movement, speed, maneuvering, heading, direction, etc. of the vehicle. The autonomous or semi-autonomous driving systems 580 may control some or all of these vehicle systems 558 and, thus, may be semi-or fully autonomous.

Network 590 may be a conventional type of network, wired or wireless, and may have numerous different configurations including a star configuration, token ring configuration, or other configurations. Furthermore, the network 590 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 590 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VoLTE, 5G-V2X or any other mobile data network or combination of mobile data networks. Further, the network 590 may include one or more IEEE 802.11 wireless networks.

In some embodiments, the network 590 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VoLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

During operation of the vehicle, behavior cloning circuit 510 may receive vehicle data from various vehicle sensors that represent vehicle states of the vehicle over time. Communication circuit 501 can be used to transmit and receive information between behavior cloning circuit 510 and sensors 552, and behavior cloning circuit 510 and vehicle systems 558. Also, sensors 552 may communicate with vehicle systems 558 directly or indirectly (e.g., via communication circuit 501 or otherwise). The states of the vehicle may include vehicle position data, for example, received from vehicle positioning system 572; vehicle speed (ν), for example, from vehicle speed sensors 520; and vehicle heading (ψ), for example, from accelerometer 522; along with any other data as needed. The states may be provided as time-series data.

In various examples, the vehicle states collected by sensors 552 and/or vehicle systems 558 may represent expert vehicle states. In some examples, Communication circuit 501 may be used to communicate the expert vehicle states to computer system 102, which can record the states as training trajectories for training machine learning models. In another example, behavior cloning circuit 510 may aggregate the expert vehicle states to generate training trajectories, which can be communicate to computer system 102 via communication circuit 501.

In another example, behavior cloning circuit 510 may receive one or more trained machine learning models 550 from computer system 102. Communication circuit 501 can be used to receive a trained model from computer system 102, which can be stored to memory 508 as an executable file as one or more trained machine learning models 550. Behavior cloning circuit 510 may then obtain vehicle states from sensors 552 and/or vehicle systems 558 via communication circuit 501 and apply the vehicle states to one or more trained machine learning models 550. One or more trained machine learning models 550 generates a planned trajectory, which can be conveyed vehicle systems 558 (e.g., autonomous or semi-autonomous driving systems 580) via communication circuit 501 for use in performing behavior cloning. In an example, autonomous or semi-autonomous driving systems 580 may attempt to imitate the planned trajectory by minimizing errors between the planned trajectory and actual vehicle states obtained by sensors 552 and/or vehicle systems 558.

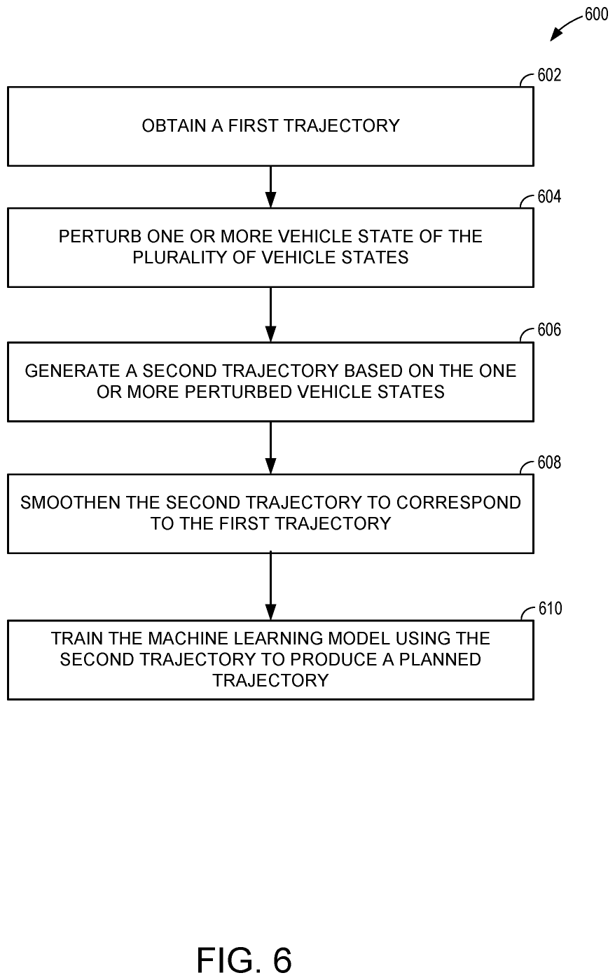

FIG. 6 is a flow chart illustrating example operations for behavior cloning, in accordance with one or more embodiments of the disclosure. Process 600 may be implemented as instructions, for example, stored on computer system 102, that when executed by one or more processors perform one or more operations of process 600. In another example, process 600 may be implemented as instructions stored on behavior cloning circuit 510, that when executed by one or more processors to perform one or more operations of process 600. While the following description will be made with reference to vehicular systems, the embodiments disclosed herein may be applied to other systems as desired.

At operation 602, a first trajectory can be obtained. The first trajectory may be, for example, a training trajectory that can be used to train a machine learning model. As described above in connection with FIGS. 1-3, the training trajectory may comprise a sequence of expert vehicle states that comprises a plurality of component data (e.g., heading, position, speed, etc.). The expert vehicles states may be based on vehicle data collected by a vehicle while executing maneuvers, which the machine learning model is to be trained to imitate.

At operation 604, one or more vehicle states of the first trajectory are perturbed, for example, by applying noise to one or more components of the vehicle states. For example, as described above in connection with FIG. 1, random noise may be applied to at least one of: speed data, heading data, and position data of the one or more vehicle states. In an illustrative example, noise is applied to an initial vehicle state of the first trajectory.

At operation 606, a second trajectory is generated based on the one or more perturbed vehicle states. For example, the one or more perturbed vehicle states may be used in place of the one or more vehicle states in the first trajectory and a modified first trajectory generated using the perturbed vehicle states. In an illustrative example, a perturbed vehicle state is used as an initial vehicle state for generating the second trajectory.

At operation 608, the second trajectory is smoothed so to correspond to the first trajectory. For example, using the one or more perturbed vehicle states as states of the second trajectory, other vehicle states can be generated for the second trajectory that converge to the first trajectory. For example, as described above in connection with FIGS. 1 and 2, operation 608 may include modifying the training trajectory with the perturbed initial state is an input (e.g., a desired setpoint) and a second trajectory as an output (e.g., the process variable). As a result, operation 608 can operate to smooth the second trajectory by converging the second trajectory to the first trajectory, as shown in FIG. 2. In an example implementation, operation 608 may be executed by a PID controller.

At operation 610, the second trajectory can be used to train the machine learning model to produce planned trajectories that attempt to imitate the second trajectory. As described above, the machine learning model can be trained to account for deviations—represented as the perturbed vehicle states—in actual trajectories relative to training trajectories. In an example, training datasets applied to the machine learning model can be updated to include the second trajectory as a new training trajectory.

In some examples, a collision loss function can be added to the machine learning model. In one example the collision loss function can be added at operation 610, while in another example, the collision loss function can be executed by another operation prior to, after, or in parallel with operation 610. As described above in connection with FIGS. 1 and 3, the collision loss function can be provided to account for unsafe conditions that may arise along the second trajectory, due to perturbing the vehicle states.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. This can include a processor, and/or any one or more of the components making up computer system 102 of FIG. 1 and/or behavior cloning circuit 510 of FIG. 5. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. For example, memory main memory 708 may store instructions for executing operations of process 600. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 722, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
obtaining a first trajectory for a machine learning model, the first trajectory comprises a sequence of a plurality of vehicle states;
perturbing at least one of the plurality of vehicle states;
generating a second trajectory based on the at least one perturbed vehicle state;
smoothening the second trajectory to correspond to the first trajectory; and
training the machine learning model using the smoothened second trajectory to produce a planned trajectory for controlling a vehicle.

2. The method of claim 1, further comprising:
introducing a collision loss function to the machine learning model based on the second trajectory; and
training the machine learning model to minimize the collision loss function.

3. The method of claim 2, wherein the collision loss function is based on detecting a collision of an ego vehicle and a road agent along the second trajectory and determining a magnitude of the collision, wherein minimizing the collision loss function is based on the magnitude of the collision.

4. The method of claim 1, wherein the plurality of vehicle states are based on vehicle data collected by a vehicle while performing a maneuver.

5. The method of claim 1, wherein the at least one of the plurality of vehicle states is an initial vehicle state of the sequence of the plurality of vehicle states.

6. The method of claim 5, wherein generating the second trajectory is based on the perturbed first vehicle state as an initial state of the second trajectory.

7. The method of claim 1, wherein perturbing at least one of the plurality of vehicle states comprises:
applying noise to the at least one of the plurality of vehicle states.

8. The method of claim 7, wherein the noise comprises a zero mean Gaussian noise.

9. The method of claim 1, wherein smoothening the second trajectory to correspond to the first trajectory comprises:
applying a control loop with feedback to converge the second trajectory to the first trajectory.

10. The method of claim 1, further comprising:
deploying the trained machine learning model on one or more vehicles for generating planned trajectories that account for deviations in actual trajectories relative to training trajectories.

11. A system, comprising:
a memory storing instructions; and
one or more processors communicably coupled to the memory and configured to execute the instructions to:
obtain a training trajectory used to train a machine learning model, the training trajectory comprises a sequence of a plurality of vehicle states;
perturb at least one of the plurality of vehicle states;
generate a modified training trajectory based on the at least one perturbed vehicle state and convergence to the training trajectory; and
train the machine learning model using the training trajectory to produce a planned trajectory.

12. The system of claim 11, wherein the one or more processors are further configured to execute the instructions to:
introduce a collision loss function to the machine learning model based on the modified training trajectory; and
train the machine learning model to minimize the collision loss function.

13. The system of claim 11, wherein the plurality of vehicle states are based on vehicle data collected by a vehicle while performing a maneuver.

14. The system of claim 11, wherein the at least one of the plurality of vehicle states is an initial vehicle state of the sequence of the plurality of vehicle states.

15. The system of claim 11, wherein perturbing at least one of the plurality of vehicle states comprises:
applying noise to the at least one of the plurality of vehicle states.

16. The system of claim 11, wherein the one or more processors are further configured to execute the instructions to:
smoothen the modified training trajectory to correspond to the training trajectory based on applying a control loop to converge the modified training trajectory to the training trajectory.

17. The system of claim 11, wherein the one or more processors are further configured to execute the instructions to:
deploy the trained machine learning model on one or more vehicles for generating planned trajectories that account for deviations in actual trajectories relative to training trajectories.

18. A computer system, the computer system comprising:
a memory storing instructions; and
one or more processors communicably coupled to the memory and configured to execute the instructions to:
generate second trajectory data based on applying noise to first trajectory data;
create a collision loss function based on the second trajectory data; and
train a machine learning model based on the second trajectory data and the collision loss function to generate planned trajectories for controlling a vehicle.

19. The computer system of claim 18, wherein the noise comprises a zero mean Gaussian noise.

20. The computer system of claim 18, wherein the one or more processors are further configured to execute the instructions to:
deploy the trained machine learning model on one or more vehicles for generating planned trajectories that account for deviations in actual trajectories relative to first trajectory data.
